(19) United States
(12) Patent Application Publication
(10) Pub. No.: US 2011/0242081 A1
(43) Pub. Date: Oct. 6, 2011

(54) METHOD OF DRIVING INFORMATION DISPLAY PANEL

(75) Inventors: Shuhei Yamada, Tokyo (JP); Hajime Tamura, Kanagawa (JP); Takanori Shoji, Tokyo (JP); Keita Ishii, Tokyo (JP); Shinya Tsuchida, Tokyo (JP); Kimitoshi Aoki, Tokyo (JP)

(73) Assignee: BRIDGESTONE CORPORATION, Chuo-ku, Tokyo (JP)

(21) Appl. No.: 13/139,176

(22) PCT Filed: Dec. 8, 2009
(86) PCT No.: PCT/JP2009/006691

§ 371 Date: Jun. 10, 2011

(30) Foreign Application Priority Data
Dec. 12, 2008 (JP) 2008-317034

(51) Int. Cl. G06F 3/038

(52) U.S. Cl. 345/211

(57) ABSTRACT

Provided is a method of driving an information display panel in which: at least two types of display media comprised of particle groups containing chargeable particles are sealed between opposed two substrates, at least one substrate being transparent; a voltage is applied across a pair of opposed pixel electrodes formed such that conductive films provided to the respective substrates face each other to move the display media, thereby displaying an information image, wherein, at the time of deleting the information image displayed on the information display panel, application of an alternating voltage and application of positive or negative voltage two or more cycles in a row are combined to delete the information image. With this method of driving an information display panel, it is possible to sufficiently delete a history of a previously displayed information image without causing the decrease in lifetime of display-rewriting and increase in power consumption.

### TECHNICAL FIELD

The present invention relates to a method of driving an information display panel in which: at least two types of display media comprised of particle groups containing chargeable particles are sealed between opposed two substrates, at least one substrate being transparent; voltage is applied across a pair of opposing pixel electrodes formed such that conductive films provided to the respective substrates face each other to move the display media, thereby displaying an information image, and in particular, relates to a method of driving the information display panel used for deleting the information image displayed on the information display panel.

It should be noted that, in the present invention, the wording “drawing” means displaying the information image, and the wording “deleting” means displaying an solid image once before the drawing.

### RELATED ART

Conventionally, various methods are known as a method of driving an information display panel in which: a display medium comprised of a particle group containing chargeable particles is sealed between two opposed substrates, at least one substrate being transparent; voltage is applied across a pair of opposing pixel electrodes formed such that conductive films provided to the respective substrates face each other to drive the display medium, thereby displaying information such as an image.

Of the methods, there is known a driving method in which an alternating voltage is applied across the electrodes as initialization driving at the time of deleting the information image displayed on the information display panel, to prevent occurrence of aggregation of the particles constituting the display medium, and of adhesion and aggregation of the particles constituting the display medium to panel-constituting members even if displaying is repeated (see, for example, Japanese Patent Application Laid-open No. 2003-5227). FIG. 7(a) and FIG. 7(b) are diagrams for explaining one example of the conventional driving method described above. FIG. 7(a) illustrates waveforms of voltage applied to the panel, and FIG. 7(b) is a schematic view illustrating a cross section of the panel, and the voltage applied to the panel. In the drawings, the applied voltage is a voltage V₁ higher than or equal to a threshold value voltage V₀ that can generate the electric field capable of overcoming the adhesive force between the surface of the substrate and chargeable particles constituting the display medium to drive the chargeable particles.

### DISCLOSURE OF THE INVENTION

### Problems to be Solved by the Invention

In the conventional driving method described above, which utilizes the alternating voltage, it is possible to prevent the occurrence of aggregation of the particles constituting the display medium, and of adhesion and aggregation of the particles constituting the display medium to members that constitute the panel to a certain degree. However, an information image previously displayed cannot be sufficiently deleted, and remains as history. Further, the history is likely to decrease by increasing the number of repetition of the application of the alternating voltage or increasing the level of the alternating voltage applied. However, this reduces the lifetime of the information display panel in terms of display rewriting, and increases the power consumption. Yet further, in terms of voltage resistance of a driver or cost, there is a limitation for increasing the level of the alternating voltage applied.

An object of the present invention is to solve the problems described above, and to provide a method of driving an information display panel capable of sufficiently deleting a history of information images previously displayed without causing the deterioration of lifetime in terms of display rewriting, or the increase in the power consumption.

### Means for Solving the Problem

A method of driving an information display panel according to the present invention provides a method of driving an information display panel in which: at least two types of display media comprised of particle groups containing chargeable particles are sealed between opposed two substrates, at least one substrate being transparent; a voltage is applied across a pair of opposing pixel electrodes formed such that conductive films provided to the respective substrates face each other to move the display media, thereby displaying an information image, wherein, at the time of deleting the information image displayed on the information display panel, application of an alternating voltage and application of positive or negative voltage two or more cycles in a row are combined to delete the information image.

Preferred examples of the method of driving the information display panel according to the present invention include: at the time of deleting before drawing of the information image, the drawing being implemented by applying a voltage having a positive polarity, deleting the information image by application of two or more cycles of a voltage having a negative polarity and application of the alternating voltage in a sequential manner; at the time of deleting before drawing of the information image, the drawing being implemented by applying a voltage having a negative polarity, deleting the information image by application of two or more cycles of a voltage having a positive polarity and application of the alternating voltage in a sequential manner; at the time of deleting before drawing of the information image, the drawing being implemented by applying a voltage having a positive polarity, deleting the information image by application of the alternating voltage and application of two or more cycles of a voltage having a negative polarity in a sequential manner; at the time of deleting before drawing of the information image, the drawing being implemented by applying a voltage having a negative polarity, deleting the information image by application of the alternating voltage and application of two or more cycles of a voltage having a positive polarity in a sequential manner; at the time of deleting before drawing of the information image, the drawing being implemented by applying a voltage having a positive polarity, deleting the information image by application of the alternating voltage, application of two or more cycles of a voltage having a negative polarity, and application of the alternating voltage in a sequential manner; at the time of deleting before drawing of the information image, the drawing being implemented by applying a voltage having a negative polarity, deleting the information image by application of the alternating voltage, application of two or more cycles of a voltage having a positive polarity and application of the alternating voltage in a sequential manner; at the time of deleting before drawing of the information image, the drawing being implemented by applying a voltage having a positive polarity, deleting the information image by application of two or more cycles of a voltage having the positive polarity, application of the alternating voltage and application of two or more cycles of a voltage having the negative polarity in a sequential manner; and, at the time of deleting before drawing of the information image, the drawing being implemented by applying a voltage having a negative polarity, deleting the information image by application of two or more cycles of a voltage having the negative polarity, application of the alternating voltage and application of two or more cycles of a voltage having the positive polarity in a sequential manner.

### EFFECT OF THE INVENTION

According to the present invention, it is possible to obtain a method of driving an information display panel capable of sufficiently deleting a history of a previously displayed information image without causing the decrease in lifetime of display-rewriting and increase in power consumption, by, at the time of deleting the information image displayed on the information display panel, combing the application of the alternating voltage and application of the positive or negative voltage two or more cycles in a row, and then deleting the information image.

### BRIEF DESCRIPTION OF THE DRAWINGS

FIGS. 1(a) and 1(b) are diagrams for explaining an example of an information display panel to which a driving method according to the present invention is directed.

FIGS. 2(a) and 2(b) are diagrams for explaining another example of an information display panel to which the driving method according to the present invention is directed.

FIG. 3 is a diagram for explaining an example of a voltage waveform according to the method of driving the information display panel of the present invention.

FIG. 4 is a diagram for explaining another example of a voltage waveform according to the method of driving the information display panel of the present invention.

FIG. 5 is a diagram for explaining still another example of a voltage waveform according to the method of driving the information display panel of the present invention.

FIG. 6 is a diagram for explaining still another example of a voltage waveform according to the method of driving the information display panel of the present invention.

FIGS. 7(a) and 7(b) are diagrams for explaining an example of a conventional driving method.

### BEST MODE FOR CARRYING OUT THE INVENTION

First, a configuration of an information display panel to which the present invention is applied will be described. In the information display panel to which a driving method according to the present invention is applied, display media comprised of particle groups containing chargeable particles are sealed between two opposed substrates, and an electric field is applied to the display medium. The display media are drawn by force resulting from the electric field or Coulomb force along the direction of the applied electric field, and move due to change of directions of the applied electric field, whereby information such as an image is displayed. Therefore, the display information panel needs to be designed so as to he able to uniformly move the display medium, and maintain stability at the time when the displayed information is repeatedly rewritten, or when the displayed information continues to be displayed. In addition to the attraction force caused by the Coulomb force between the respective particles, the force acting on the particles constituting the display medium may include electric imaging force with the electrode or substrate, intermolecular force, liquid bonding force, gravity and the like.

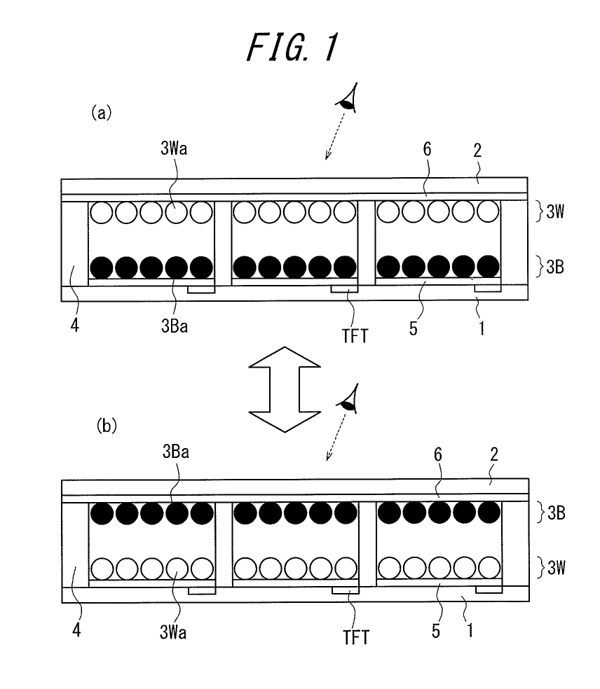

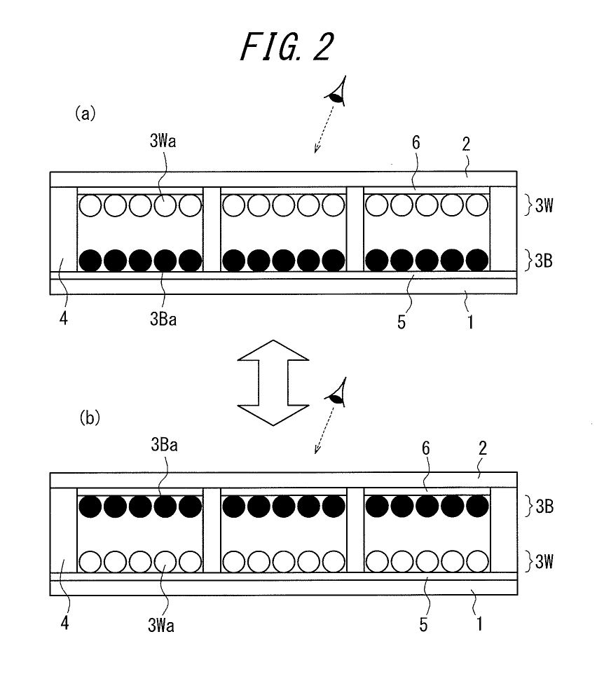

An example of the information display panel to which the driving method according to the present invention is directed will be described with reference to FIGS. 1(a) and 1(b) through FIGS. 2(a) and 2(b).

In the example illustrated in FIGS. 1(a) and 1(b), at least two types of display media (in this example, a white color display medium 3W comprised of a particle group containing negatively charged white color particles 3Wa and a black color display medium 3B comprised of a particle group containing positively charged black color particles 3Ba are illustrated) comprised of particle groups containing particles having at least an optical reflectivity and a charging property, which are different between the display medium types, are moved perpendicular to substrates 1, 2 in each cell formed by a partition wall 4 in accordance with an electric field generated by applying a voltage across a pair of pixel electrodes formed by an electrode 5 (pixel electrode with TFT) provided to the substrate 1 and an electrode 6 (common electrode) provided to the substrate 2, the respective electrodes of which face each other. Then, a white display can be performed by making the white color display medium 3W visually recognized by an viewer as illustrated in FIG. 1(a), or a black display can be performed by making the black color display medium 3B visually recognized by the viewer as illustrated in FIG. 1(b), whereby matrix display of white and black dots can be performed. Note that, in FIGS. 1(a) and 1(b), a partition wall existing at the frontward side is omitted.

In an example illustrated in FIGS. 2(a) and 2(b), at least two types of display media (in this example, a white color display medium 3W comprised of a particle group containing negatively charged white color particles 3Wa and a black color display medium 3B comprised of a particle group containing positively charged black color particles 3Ba are illustrated) comprised of particle groups containing particles having at least an optical reflectivity and a charging property, which are different between the display medium types, are moved perpendicular to substrates 1, 2 in each cell formed by a partition wall 4 in accordance with an electric field generated by applying a voltage across a pair of pixel electrodes formed by a line electrode 6 provided to the substrate 2 and a line electrode 5 provided to the substrate 1 in a manner that the respective electrodes face each other and perpendicularly intersect each other. Then, a white display can be performed by making the white color display medium 3W visually recognized by a viewer as illustrated in FIG. 2(a), or a black display can be performed by making the black color display medium 3B visually recognized by the viewer as illustrated in FIG. 2(b), whereby matrix display of white and black of dots can be performed. Note that, in FIGS. 2(a) and 2(b), a partition wall existing at the frontward side is omitted.

The driving method according to the present invention is characterized in that, in the information display panel having the structure described above, the information image is deleted by combining application of alternating voltage and application of positive or negative voltage two cycles or more in a row at the time of deleting the information image displayed on the information display panel. In the driving method according to the present invention, the positive or negative voltage may be applied at any timing in before, after and in the middle of the application of the alternating voltage, and combination thereof.

The waveform of the positive or negative voltage applied two or more cycles in a row may be a rectangular wave, trapezoidal wave, sine wave or triangular wave, and is not particularly limited. However, the rectangular wave is the most effective waveform to sufficiently erase the previously displayed information image. It is not necessary to keep the amplitude and cycle of the voltage waveform and the number of repetition at a constant. Note that either a passive drive or active drive may be possible for the driving method according to the present invention. Further, at the time of deleting, the voltage may be applied to the entire panel or a part of the panel.

According to the driving method of the present invention, the voltage waveform of the positive or negative voltage to be applied is limited to “two cycles or more” for the following reason. That is, as compared with the case where the voltage is applied one cycle, the particle group in the panel can be more likely to be separated into individual particles in the case where the voltage is applied two or more cycles in a row. At the time of applying the voltage, charged particles having different polarities move toward opposite directions to each other in the panel, and collide with each other before reaching the respective opposing electrodes. In the case where the voltage is applied one cycle, there exist particles that cannot reach the respective opposing electrodes because, once the particles collide with each other, they adhere to each other or return back. Therefore, the particle group cannot be sufficiently separated into the individual particles. On the other hand, by applying the voltage two or more cycles, even if the particles collide with each other once, the colliding particles receive the force toward the respective opposing electrodes resulting from the electric field generated by the voltage in the second cycle or later, whereby it is possible to increase the possibility that particles can reach the respective opposing electrodes. Therefore, it is possible to sufficiently separate the at least two types of the particle groups constituting the at least two types of display media into the individual particles. Further, as for the cycles, the upper limit of the number of cycle is not specifically limited, provided that the number of the cycle is two or more from the viewpoint of sufficiently deleting the history of the previously displayed information image. However, even if the number of cycle increases, its effect saturates to be constant, and the power consumption increases accordingly. Therefore, it is preferable to set the upper limit to about 30 cycles.

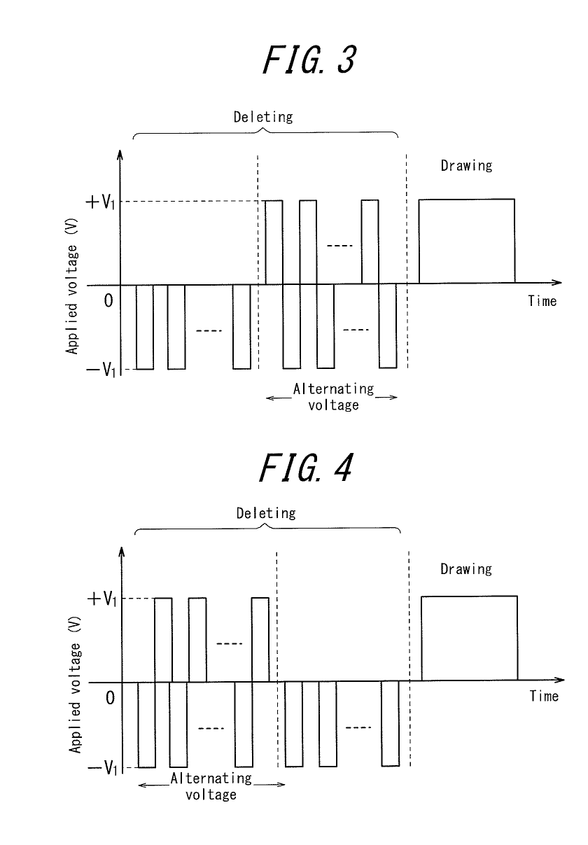

Below, a specific example of the voltage waveform will be described with reference to FIG. 3 to FIG. 6. In this example, the information display panel employs two types of display media: a display medium comprised of a particle group containing positively charged particles and a display medium comprised of a particle group containing negatively charged particles. However, the combination of the alternating voltage and the positive or negative voltage two or more cycles is not limited.

FIG. 3 is a diagram for explaining an example of the voltage waveform according to the method of driving the information display panel of the present invention. In the example illustrated in FIG. 3, drawing is performed by applying a positive voltage, in other words, a voltage having a positive property at an electrode on the viewer side with respect to an electrode on the rear surface side when an electrode on the viewer side constituting the information display panel is a reference (for example, the electrode on the viewer side is +V₁(V), whereas the electrode on the rear surface side is 0 (V)). The V₁ is a voltage value larger than a threshold voltage value V₀, and is applied for generating the electric field sufficient to drive the chargeable particles constituting the display media.

In the example illustrated in FIG. 3, at the time of deleting before the information image is drawn as described above, the negative voltage is first applied two or more cycles, and then, the alternating voltage is applied. In this example, the application of negative voltage means application of a voltage having a negative property at the electrode on the viewer side with respect to the electrode on the rear surface side when the electrode on the viewer side constituting the information display panel is a reference (for example, the electrode on the viewer side is −V₁(V), whereas the electrode on the rear surface side is 0 (V)). Further, the alternating voltage means a voltage in which a positive voltage and a negative voltage alternately appear. In this example, the drawing is performed by applying the positive voltage.

FIG. 4 is a diagram for explaining another example of the voltage waveform according the method of driving the information display panel of the present invention. The example illustrated in FIG. 4 shows an example where drawing is performed by applying the positive voltage. In this example, at the time of deleting before the drawing described above, the alternating voltage is first applied, and then, the negative voltage is applied two or more cycles. In this example, the drawing is performed by applying the positive voltage.

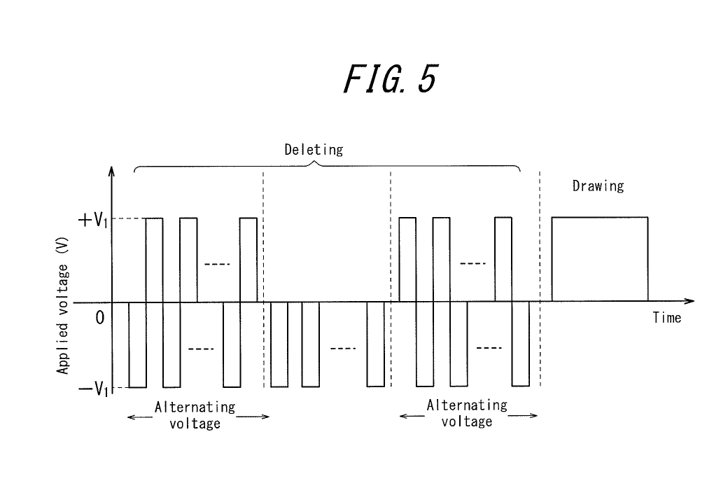

FIG. 5 is a diagram for explaining another example of the voltage waveform according to the method of driving the information display panel of the present invention. The example illustrated in FIG. 5 shows an example in which drawing is performed by applying the positive voltage. In this example, at the time of deleting before the information image is drawn as described above, the alternating voltage is first applied; then, the negative voltage is applied two or more cycles; and then, the alternating voltage is applied.

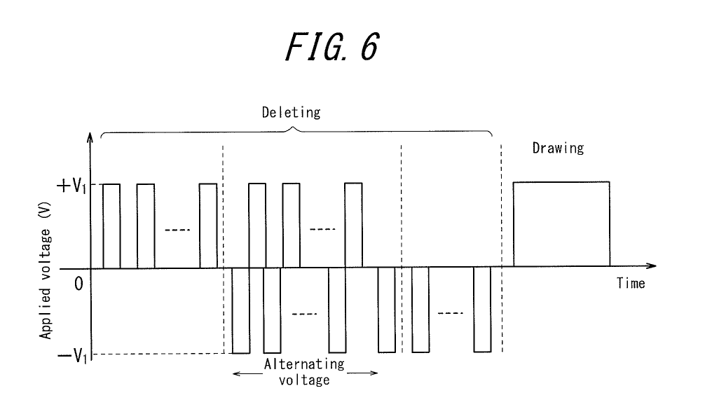

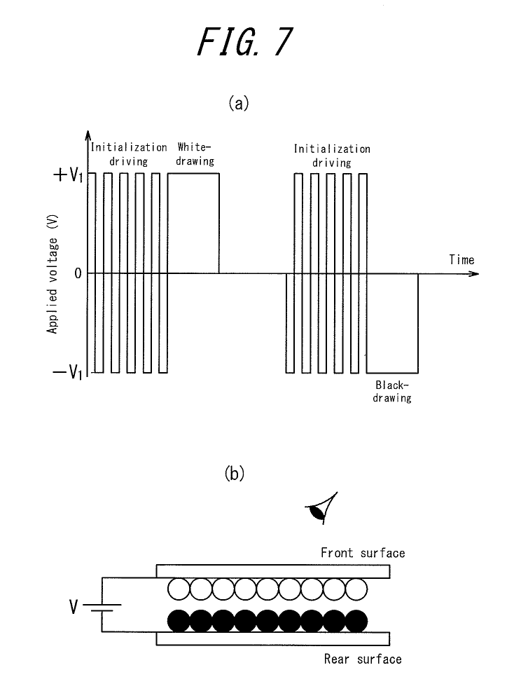

FIG. 6 is a diagram for explaining another example of the voltage waveform according to the method of driving the information display panel of the present invention. The example illustrated in FIG. 6 shows an example in which drawing is performed by applying the positive voltage. In this example, at the time of deleting before the information image is drawn as described above, the positive voltage is first applied two or more cycles; then, the alternating voltage is applied; and then, the negative voltage is applied two or more cycles.

In the examples illustrated in FIG. 3 to FIG. 6, the shape of the pulse voltage is rectangular wave, but it may be possible to employ other shapes such as a trapezoidal wave, sine wave and triangular wave. Further, the voltage level of each of the pulses, the time duration for which the pulse voltage is applied (ON time), and the time duration for which the pulse voltage is not applied (OFF time) are equal to each other, but may be set separately. Yet further, drawing is performed by applying the positive voltage, but it is possible to perform the drawing by applying the negative voltage. Note that, of the examples illustrated in FIG. 3 to FIG. 6, the example illustrated in FIG. 6 is the most effective one.

Next, description will be made of each member constituting the information display panel to which the driving method according to the present invention is directed.

As for substrates, at least one of the substrates is a transparent substrate through which the display media can be recognized from the outside of the panel, and is formed preferably of a material having high transmissivity for the visible light and favorable heat-resisting property. On the other hand, the substrate on the rear surface side, which is the other substrate, may be transparent, or may not be transparent. Examples of substrate materials include an organic-polymer-based substrate such as polyethylene terephthalate (PET), polyethylene naphthalate (PEN), polyethylene (PE), polycarbonate (PC), polyimide (PI), polyethersulfone (PES) and acrylic, a glass sheet, a quartz sheet, a metal sheet coated with the insulation film and the like. Of the materials described above, a transparent material is used for the display surface side. The thickness of the substrate is preferably in the range of 2 to 2000 μm, and more preferably in the range of 5 to 1000 μm. In the case where the substrate is too thin, it is difficult to maintain the strength and uniformity of the space between the substrates. On the other hand, in the case where the thickness exceeds 2000 μm, inconvenience occurs at the time of making the display panel thinner.

Examples of materials for forming the electrode include: metals such as aluminum, silver, nickel, copper and gold; conductive metallic oxides such as indium tin oxide (ITO), indium zinc oxide (IZO), aluminum doped zinc oxide (AZO), indium oxide, conductive tin oxide, antimony tin oxide (ATO) and conductive zinc oxide; and conductive polymers such as polyaniline, polypyrrole and polythiophene, and depending on applications, it is possible to select from the materials described above to use. As a method of forming the electrode, it is possible to use: a method of subjecting the materials exemplified above to pattern formation to be a thin film shape by using a sputtering method, a vacuum deposition method, a chemical vapor deposition (CVD) method and a coating method; a method of laminating metal foils (for example, rolling copper-foil method); and a method of performing pattern formation by applying a mixture of conductive agent with solvent or synthetic resin binder. The electrode provided on the substrate on the viewer side (display surface side) needs to be transparent, while it is not necessary for the electrode provided on the back side substrate to be transparent. In any case, it is possible to preferably use the above-described conductive materials that can be used for pattern formation. Note that a thickness of the electrode is set by considering the conductivity and optical transparency, and is in the range of 0.01 to 10 μm, preferably, in the range of 0.05 to 5 μm. For the material and thickness of the electrode provided on the back side substrate, it is not necessary to consider the optical transparency.

Depending on application, a shape of a partition wall provided to the substrate is optimally set in accordance with types of display media concerning display, and shapes and arrangement of the electrode to be disposed, and is not limited flatly, and the width of the partition wall is set in the range of 2 to 100 μm, preferably, in the range of 3 to 50 μm. The height of the partition wall is set in the range of 10 to 500 μm, and preferably, in the range of 10 to 200 μm. The height of a partition wall for securing a gap between the substrates is set so as to match the gap between the substrates that is desired to be secured. The height of a partition wall disposed for partitioning the space between the substrates into cells is set to the height same as the gap between the substrate or to the height lower than the gap between the substrate.

Further, it is considered that the partition wall is formed by a both-rib method of forming a rib on both of the opposing substrates 1, 2 and then connecting them, or by a single-rib method of forming a rib only on the single side substrate of the two substrates. In this invention, either method is possible.

Examples of the cells formed by the partition formed by the rib described above include a quadrangle shape, triangle shape, line shape, circle shape and hexagonal shape as viewed from the direction of the substrate plane, and examples of arrangement thereof include a lattice arrangement, honey-comb arrangement and network arrangement. It is preferable that a portion corresponding to a sectional portion of the partition wall visible from the display surface side (area of frame portion of cell) is set as small as possible, so that sharpness of the displaying state can be increased.

Examples of the method of forming the partition wall include a mold transfer method, a screen printing method, a sandblast method, a photolithographic method, and an additive method. Any method can be preferably applied to the information display panel provided to the information display device according to the present invention, but, of the methods described above, the photolithographic method using a resist film or the mold transfer method is preferably used.

Next, the chargeable particles contained in the particle groups constituting the display media in the present invention will be described. The chargeable particles are employed in a manner that only the chargeable particles form the particles group to constitute the display media, or the chargeable particles are combined with other particles, and forms the particle group to constitute the display media.

The chargeable particles are formed principally by resins, and, may contain a charging control agent, colorant, inorganic additive and the like depending on applications. Examples of the resins, charging control agent, colorant, and other additives will be described below.

Examples of the resins include a urethane resin, urea resin, acrylic resin, polyester resin, acrylic urethane resin, acrylic urethane silicone resin, acrylic urethane fluororesin, acrylic fluororesin, silicone resin, acrylic silicone resin, epoxy resin, polystyrene resin, styrene-acrylic resin, polyolefin resin, butyral resin, vinylidene chloride resin, melamine resin, phenol resin, fluororesin, polycarbonate resin, polysulfone resin, polyether resin, and polyamide resin, and two or more resins may be mixed. In particular, from the viewpoint of control of adhesion strength with the substrate, it is preferable to use the acrylic urethane resin, acrylic silicone resin, acrylic fluororesin, acrylic urethane silicone resin, acrylic urethane fluororesin, fluororesin, and silicone resin.

There is not any particular limitation for the charging control agent, but examples of negative charging control agents include salicylic acid metal complex, metal-containing azo dye, metal-containing (including metal ion or metal atom) oil-soluble dye, quaternary ammonium salt compound, calixarene compounds, boron containing compound (benzilic acid boron complex), and nitroimidazole derivative. Examples of positive charging control agents include nigrosine dye, triphenylmethane-based compound, quaternary ammonium salt compound, polyamine resin, and imidazole derivative. Additionally, it may be possible to employ, as the charging control agent, ultrafine powder silica; ultrafine powder titanium oxide; metallic oxides such as ultrafine powder alumina; nitrogen containing ring compound such as pyridine and its derivative; and resin containing salt, various kinds of organic pigments, fluorine, chlorine and nitrogen.

As exemplified below, various types and colors of organic and inorganic pigments and dyes may be used as the colorant.

Black colorant includes carbon black, copper oxide, manganese dioxide, aniline black, active carbon and the like.

Blue colorant includes C.I. pigment blue 15:3, C.I. pigment blue 15, iron blue, cobalt blue, alkali blue lake, victoria blue lake, phthalocyanine blue, metal-free phthalocyanine blue, phthalocyanine blue partial chlorine compound, first sky blue, indanthrene blue BC and the like.

Red colorant includes colcothar, cadmium red, red lead, mercury sulfide, cadmium, permanent red 4R, lithol red, pyrazolone red, watching red, calcium salt, lake red D, brilliant carmine 6B, cosine lake, rhodamine lake B, alizarin lake, brilliant carmine 3B, C.I. pigment red 2 and the like.

Yellow colorant includes chrome yellow, zinc yellow, cadmium yellow, yellow iron oxide, mineral first yellow, nickel titanium yellow, navel yellow, naphthol yellow S, hansa yellow G, hansa yellow 10G, benzidine yellow G, benzidine yellow GR, quinoline yellow lake, permanent yellow NCG, tartrazine lake, C.I. pigment yellow 12 and the like.

Green colorant includes chrome green, chromium oxide, pigment green B, C.I. pigment green 7, Malachite green lake, final yellow green G and the like.

Orange colorant includes red chrome yellow, molybdenum orange, permanent orange GTR, pyrazolone orange, Balkan orange, indunsren brilliant orange RK, benzidine orange G, Indusren brilliant orange GK, C.I. pigment orange 31 and the like.

Purple colorant includes manganese purple, first violet B, methyl violet lake and the like.

White colorant includes zinc oxide, titanium oxide, antimony white, zinc sulfide and the like.

Extender includes baryta powder, barium carbonate, clay, silica, white carbon, talc, alumina white and the like. Further, as various dyes such as basic dye, acidic dye, dispersion dye, direct dye and the like, there are nigrosine, methylene blue, rose bengal, quinoline yellow, ultramarine blue, and the like.

Examples of inorganic additives include titanium oxide, zinc oxide, zinc sulfide, antimony oxide, calcium carbonate, white lead, talc, silica, calcium silicate, alumina white, cadmium yellow, cadmium red, cadmium orange, titanium yellow, iron blue, ultramarine blue, cobalt blue, cobalt green, cobalt violet, iron oxide, carbon black, manganese ferrite black, cobalt ferrite black, copper powder, aluminum powder and the like.

The pigments and inorganic additives described above may be used alone or in combination therewith. In particular, of the colorants described above, carbon black is preferable as the black pigment, and titanium oxide is preferable as the white pigment. Chargeable particles having a desired color can be manufactured by mixing the colorants described above.

Further, it is preferable that the chargeable particles (hereinafter, also referred to as particles) have an average particle diameter d(0.5) in the range of 1 to 20 μm, and the respective particles have a uniform size. In the case where the average particle diameter d(0.5) exceeds this range, the image sharpness on the display deteriorates, and, on the other hand, in the case where the average particle diameter is smaller than this range, a cohesive force between the particles becomes undesirably large, which adversely affects the movement of the particles as the display medium.

Further, regarding the particle diameter distribution of the chargeable particles, a particle diameter distribution Span, which is defined by the following expression, is less than 5, preferably less than 3.

Span=(d(0.9)−d(0.1))/d(0.5)

(where, d(0.5) indicates a value of the particle diameter expressed by μm in which 50% of the particles have a diameter larger than this value and 50% of the particles have a diameter smaller than this value, d(0.1) indicates a value of the particle diameter expressed by μm in which a percentage of the particles having a diameter smaller than or equal to this value is 10%, and d(0.9) indicates a value of the particle diameter expressed by um in which a percentage of the particles having a diameter smaller than or equal to this value is 90%.)

By setting the Span to less than or equal to 5, the sizes of the chargeable particles are made uniform and the particles can move as the uniform display medium.

Yet further, in the case where plural display media are used. it is important that, for the chargeable particles constituting the display media used, a ratio of d(0.5) of the chargeable particles having the minimum average particle diameter d(0.5) relative to the d(0.5) of the chargeable particles having the maximum average particle diameter d(0.5) is set to 10 or lower. Even if the particle diameter distribution Span is set to be smaller, the chargeable particles having different electrification properties from each other are moved in the opposite directions to each other, and hence, it is preferable that the sizes of the particles are formed so as to be equal to each other in order to make the respective particles easily moved, which is realized by the above-described range.

It should be noted that the particle diameter distribution and the particle diameters of the particle described above can be obtained with a laser diffraction/scattering method and the like. By emitting a laser light to the particles to be measured, a light intensity distribution pattern occurs spatially due to a diffraction/scattering light. This light intensity pattern is in the relationship with the particle diameter, and hence, the particle diameters and the particle diameter distribution can be obtained.

In the present invention, the particle diameters and the particle diameter distribution are obtained on the basis of the volume-based distribution. More specifically, measurement is performed by using a measurement unit Mastersizer 2000 (Malvern Instruments Ltd.) such that particles are inserted into a stream of nitrogen, and the particle diameters and the particle diameter distribution are measured with the attached analysis software (software using a Mie theory and based on the volume-based distribution).

Further, for the information display panel in which display media containing chargeable particles are driven in a space filled with gas, it is important to manage the gas located in the space and surrounding the display media between the panel substrates, which contributes to improvement of display stability. More specifically, it is important to set a relative humidity of the gas in the space at 25° C. at 60% RH or lower, preferably, at 50% RH or lower.

The space described above represents a portion existing between the opposing substrate 1 and substrate 2 in FIGS. 1(a) and 1(b) through FIGS. 2(a) and 2(b), excluding the electrodes 5, 6 (in the case where the electrodes are provided on the inner side of the substrates), a portion occupied by the display media 3, a portion occupied by the partition wall 4 (in the case where the partition wall is provided) and a sealing portion of the panels, in other words, the space described above indicates a gas portion that is brought in contact with the display media.

Any type of gas can be used as the gas in the spaces described above, provided that humidity thereof falls within the humidity range described above. However, it is preferable to use a dried air, dried nitrogen, dried argon, dried helium, dried carbon dioxide, dried methane and the like. This gas needs to be sealed in the panels so as to keep the humidity inside thereof, and it is important, for example, to fill the display media, build the panels and implement other processes under a predetermined humidity environment, and then, to apply the seal material and sealing method so as to prevent the wet from intruding from the outside.

The space between the substrates of the information display panel to which the present invention is directed is set such that the display medium can move and contrast can be maintained, and is adjusted, generally, in the range of 2 to 500 μm, preferably, in the range of 5 to 200 μm.

In the case of an information display panel in which the chargeable particles are moved in a space filled with gas, the space between the substrates is set in the range of 10 to 100 μm, preferably, in the range of 10 to 50 μm. Further, it is preferable that the volume ratio of the display media to the space filled with gas between the substrates is in the range of 5 to 70%, and more preferably, in the range of 5 to 60%. Note that, in the case where the ratio exceeds 70%, movement of the particles as the display media is adversely affected, and on the other hand, in the case where the ratio is less than 5%, the contrast is likely to become unclear.

As the type in which the chargeable particles are moved to display, there is a type in which the chargeable particles are sealed in micro capsules together with an insulating liquid, and the micro capsules are disposed between the opposing electrodes. The present invention is applicable to driving such a type of the information display panel.

### INDUSTRIAL APPLICABILITY

An information display panel to which the present invention is directed is suitable for use in: a display unit of a mobile device such as a notebook computer, a PDA, a cell phone and a handy terminal; an electronic paper such as an electronic book, an electronic newspaper and an electronic manual (instruction manual); a message board such as a billboard, a poster and a blackboard; a display unit of a calculator, an electrical appliance, an automobile part; a card display unit of a point card and an IC card; a display unit of an electronic advertisement, an electronic POP (point of presence, point of purchase advertizing), an electronic price tag, an electronic price shelf-tag, an electronic music score and a RFID device; and, a display unit that connects with an external display rewriting means to display and rewrite (so called rewritable paper).

1. A method of driving an information display panel in which: at least two types of display media comprised of particle groups containing chargeable particles are sealed between opposed two substrates, at least one substrate being transparent; a voltage is applied across a pair of opposed pixel electrodes formed such that conductive films provided to the respective substrates face each other to move the display media, thereby displaying an information image, wherein,
at the time of deleting the information image displayed on the information display panel, application of an alternating voltage and application of positive or negative voltage two or more cycles in a row are combined to delete the information image.

2. The method of driving an information display panel according to claim 1, wherein,
at the time of deleting before drawing of the information image, the drawing being implemented by applying a voltage having a first polarity, the information image is deleted by application of two or more cycles of a voltage having a second polarity and application of the alternating voltage in a sequential manner.

3. The method of driving an information display panel according to claim 1, wherein,
at the time of deleting before drawing of the information image, the drawing being implemented by applying a voltage having a first polarity, the information image is deleted by application of the alternating voltage and application of two or more cycles of a voltage having a second polarity in a sequential manner.

4. The method of driving an information display panel according to claim 1, wherein,
at the time of deleting before drawing of the information image, the drawing being implemented by applying a voltage having a first polarity, the information image is deleted by application of the alternating voltage, application of two or more cycles of a voltage having a second polarity and application of the alternating voltage in a sequential manner.

5. The method of driving an information display panel according to claim 1, wherein,
at the time of deleting before drawing of the information image, the drawing being implemented by applying a voltage having a first polarity, the information image is deleted by application of two or more cycles of the voltage having the first polarity, application of the alternating voltage, and application of two or more cycles of a voltage having a second polarity in a sequential manner.
